(19) United States
(12) Patent Application Publication
(10) Pub. No.: US 2026/0116797 A1
(43) Pub. Date: Apr. 30, 2026

(54) TANNIC ACID-MODIFIED IRON-BIOCHAR CONDUCTIVE CARRIER AND PREPARATION METHOD THEREOF AND ANAEROBIC TREATMENT METHOD FOR WASTEWATER

(71) Applicant: NANKAI UNIVERSITY, TIANJIN (CN)

(72) Inventors: XIAOYUAN ZHANG, TIANJIN (CN); YU LIU, TIANJIN (CN); JUNLI TIAN, TIANJIN (CN)

(21) Appl. No.: 19/366,125

(22) Filed: Oct. 22, 2025

(30) Foreign Application Priority Data
Oct. 26, 2024 (CN) 202411504484.3

(51) Int. Cl. C02F 3/28; C02F 101/30

(52) U.S. Cl. CPC C02F 3/2806; C02F 2101/30

(57) ABSTRACT

A tannic acid-modified iron-biochar composite conductive carrier preparation method and an anaerobic treatment method for wastewater are provided. The preparation method of the conductive carrier includes calcining a wooden raw material at a high temperature to obtain biochar, drying, and sieving; dissolving the biochar and a soluble iron salt in deionized water and performing magnetic stirring; adding tannic acid after full dissolution, and adjusting the pH with an alkali solution; and transferring with pretreated carbon felt to a reactor for hydrothermal synthesis, naturally cooling, washing with deionized water, and vacuum drying to obtain the tannic acid-modified iron-biochar composite conductive carrier. The obtained tannic acid-modified iron-biochar composite conductive carrier is used for anaerobic wastewater treatment.

### CROSS-REFERENCE TO RELATED APPLICATIONS

The present disclosure claims priority to Chinese patent application No. 2024115044843 filed with the Chinese Patent Office on Oct. 26, 2024, entitled “TANNIC ACID-MODIFIED IRON-BIOCHAR COMPOSITE CONDUCTIVE CARRIER MATERIAL AND PREPARATION METHOD AND APPLICATION THEREOF”, the entire contents of which are incorporated by reference herein.

### TECHNICAL FIELD

The present disclosure belongs to the technical field of environmental remediation and pollution control, and specifically relates to a tannic acid-modified iron-biochar composite conductive carrier, a preparation method thereof, and an anaerobic treatment method for wastewater.

### BACKGROUND ART

Environmental pollution and energy shortages are constraining global economic development. Anaerobic wastewater treatment is a promising technology for addressing these two challenges, as it may recover energy (e.g., methane) from organic pollutants. However, the performance of methanogenesis in anaerobic systems is largely affected by complex interspecific interactions and low electron transfer rates between acidogenic bacteria and methanogenic bacteria. Therefore, it has become a research hotspot to enhance electron transfer, promote microbial metabolism, and improve the performance of anaerobic methanogenesis through various regulatory strategies.

In recent years, an increasing number of carbon-based and iron-based conductive materials (such as activated carbon, graphene, Fe₃O₄, and ZVI) have been used to promote direct interspecies electron transfer (DIET) process during anaerobic treatment. Carbon-based conductive materials have a large surface area, high stability, providing a favorable environment for microbial growth. However, due to less electron transfer sites on the material surface, electron transfer between the cell surface and the carbon-based conductive material is restricted, resulting in limited ability of directly using the carbon-based conductive materials to improve methane production in anaerobic systems. Fe may serve as active sites in carbon-based conductive materials, enhancing the conductivity of the carbon-based conductive materials. Introducing iron into carbon-based conductive materials is expected to improve their electron transfer capacity and promote an increase in methane production during the anaerobic treatment process.

However, composite conductive materials used in anaerobic systems usually require cumbersome preparation processes, high preparation costs, and are difficult to recycle. The potential biological toxicity and environmental risks are not negligible, which greatly limit their engineering applications.

Therefore, how to provide a green synthesis method to prepare a new composite conductive carrier is a technical problem that needs to be solved urgently by those skilled in the art.

### SUMMARY

The embodiments of the present disclosure provide a preparation method for a tannic acid-modified iron-biochar composite conductive carrier, including the following steps:
(1) calcining a wooden raw material at a high temperature to obtain biochar, natural cooling, washing alternately with deionized water and ethanol, drying, and sieving for later use;
(2) dissolving the biochar obtained in step (1) and a soluble iron salt in deionized water and performing magnetic stirring;
(3) adding tannic acid (TA) after full dissolution to obtain a mixed solution, and adjusting the pH value of the mixed solution with an alkali solution;
(4) transferring the mixed solution after pH adjustment in step (3) together with pretreated carbon felt into a reactor for hydrothermal synthesis, natural cooling, washing with deionized water, and vacuum drying to obtain the tannic acid-modified iron-biochar composite conductive carrier.

The embodiments of the present disclosure further provide a tannic acid-modified iron-biochar composite conductive carrier prepared by the method above, where the tannic acid-modified iron-biochar conductive carrier is a Fe-TA-C composite conductive carrier (Fe-TA-C@CF) that promotes electron transfer.

The embodiments of the present disclosure further provide an application of a tannic acid-modified iron-biochar composite conductive carrier prepared by the method above in environmental remediation and pollution control technologies.

The embodiments of the present disclosure further provide an anaerobic treatment method of wastewater, including:
preparing a tannic acid-modified iron-biochar composite conductive carrier by the above preparation method;
placing the tannic acid-modified iron-biochar composite conductive carrier and anaerobic suspended sludge in an anaerobic reactor;
introducing wastewater to be treated to degrade organic pollutants through biodegradation.

### BRIEF DESCRIPTION OF DRAWINGS

In order to more clearly illustrate the technical solutions of the embodiments of the present disclosure or in the prior art, the drawings required for use in the embodiments or the prior art will be briefly introduced below. Apparently, the drawings in the following description are only embodiments of the present disclosure. For a person ordinarily skilled in the art, other drawings may be obtained based on the provided drawings without paying creative work.

FIG. 1 is a preparation flow chart of the tannic acid-modified iron-biochar composite conductive carrier of the present disclosure.

FIG. 2A is a scanning electron microscope image of the iron-biochar composite conductive carrier in Example 1; and FIG. 2B is a scanning electron microscope image of the tannic acid-modified iron-biochar composite conductive carrier in Example 1.

FIG. 3A shows the cyclic voltammograms of the iron-biochar composite conductive carrier and the tannic acid-modified iron-biochar composite conductive carrier in Example 2; and FIG. 3B shows the electrochemical impedance spectroscopy plots of the iron-biochar composite conductive carrier and the tannic acid-modified iron-biochar composite conductive carrier in Example 2.

FIG. 4 is a schematic structural diagram of the anaerobic bioreactor bottle in Application Example 1, in which the carrier used is an iron-biochar composite conductive carrier or a tannic acid-modified iron-biochar composite conductive carrier.

FIG. 5A shows the TOC concentration variations of the iron-biochar composite conductive carrier (Fe—C@CF) and the tannic acid-modified iron-biochar composite conductive carrier (Fe-TA-C@CF) in Application Example 1 measured at different reaction times during the enhanced anaerobic biological treatment process of wastewater; and FIG. 5B shows the total biogas production diagram of the iron-biochar composite conductive carrier (Fe—C@CF) and the tannic acid-modified iron-biochar composite conductive carrier (Fe-TA-C@CF) in Application Example 1 measured at different reaction times during the enhanced anaerobic biological treatment process of wastewater.

FIG. 6 is a schematic diagram of the anaerobic fixed biofilm reactor in Application Example 2.

FIG. 7 shows the variations of daily gas production (including daily methane production and daily carbon dioxide production) over time in the anaerobic fixed biofilm reactor constructed with the tannic acid-modified iron-biochar composite conductive carrier of Example 4.

### REFERENCE NUMERALS

10—anaerobic bioreactor bottle; 20—anaerobic fixed biofilm reactor;
1—anaerobic suspended sludge; 2—headspace gas zone; 3—gas collection bag; 4—composite conductive carrier; 5—sampling needle; and
21—transparent circular gas collecting tube; 6—Fe-TA-C@CF carrier model; 7—disc; 8—peristaltic pump.

### DETAILED DESCRIPTION OF EMBODIMENTS

The technical solutions in the embodiments of the present disclosure will be clearly and completely described below. Obviously, the embodiments described are only some of the embodiments of the present disclosure, not all of them. Based on the embodiments of the present disclosure, all other embodiments obtained by a person ordinarily skilled in the art without making any creative efforts fall within the scope of protection of the present disclosure.

Herein, with respect to the specialized term “example/embodiment”, any embodiment illustrated as “exemplary” shall not be construed as being superior to or better than other embodiments. For the performance index tests in the examples of the present disclosure, unless otherwise specified, conventional test methods in the field are adopted. It should be understood that the terms used in the present disclosure are intended merely to describe specific embodiments and are not intended to limit the present disclosure herein.

Unless otherwise specified, the technical and scientific terms used herein have the same meanings as commonly understood by a person ordinarily skilled in the technical field to which the present disclosure belongs; and other experimental methods and technical means not specifically specified in the present disclosure refer to experimental methods and technical means commonly used by a person ordinarily skilled in the art.

In order to better illustrate the content of the present disclosure, numerous specific details are provided in the specific examples below. It should be understood by those skilled in the art that the present disclosure may be implemented without certain specific details. In the examples, some methods, means, instruments, equipment, etc., well known to those skilled in the art are not described in detail in order to highlight the main purpose of the present disclosure.

Under the premise of no conflict, the technical features disclosed in the embodiments of the present disclosure may be combined arbitrarily, and the resulting technical solutions belong to the contents disclosed in the embodiments of the present disclosure.

The present disclosure discloses a tannic acid-modified iron-biochar composite conductive carrier, and a preparation method and application thereof. By utilizing a green synthesis method to prepare the novel composite conductive carrier, the recovery issue of conductive materials in anaerobic systems is addressed, methane production is increased, and microbial metabolism and direct interspecies electron transfer processes are accelerated.

It should be indicated that tannic acid (TA), as a biodegradable natural plant polyphenol, not only possesses excellent metal chelation and electron transfer properties, but its own aromatic and quinone groups may also affect the anaerobic treatment process. Low-temperature heat treatment enables the maximum retention of oxygen-containing functional groups in the tannic acid-iron complex, improves its redox activity, and promotes electron transfer. Iron and TA form a stable complex under neutral or weakly alkaline conditions.

Introducing carbon felt (CF), a conductive carrier, during the preparation process allows the conductive composite material to be grown in situ on the carrier through a one-pot hydrothermal method, offering advantages such as facilitated mass transfer, reduced internal resistance, and improved microbial adhesion. Meanwhile, the green synthesis by using plant polyphenols is more environmentally friendly and cost-effective, and its enhancing effect on anaerobic wastewater treatment is more durable and stable compared to that of single carriers or iron/carbon materials. Therefore, the method of using tannic acid to prepare a novel green Fe-TA-C composite conductive carrier by using low-temperature heat treatment in the present disclosure is a promising strategy for enhancing direct interspecies electron transfer (DIET) during anaerobic processes.

The embodiments of the present disclosure provide a preparation method for a tannic acid-modified iron-biochar composite conductive carrier, including the following steps:

(1) calcining a wooden raw material at a high temperature to obtain biochar, natural cooling, washing alternately with deionized water and ethanol, drying, and sieving for later use.

It should be indicated that the biochar prepared from waste raw materials in step (1) is an environmentally friendly medium, where the rich porous structure provides more favorable conditions for the attachment of microbials and provides good active sites for electron transfer in anaerobic systems.

(2) dissolving the biochar obtained in step (1) and a soluble iron salt in deionized water and performing magnetic stirring for 30-40 min.

It should be noted that the electrical conductivity of biochar may be improved by doping with a small amount of iron.

(3) adding tannic acid (TA) after full dissolution, continuing stirring for 6-8 h, adjusting the pH value of the resulting mixed solution to 7-9 by using NaOH or KOH.

It should be indicated that tannic acid (TA) may be tightly bound to the carbon substrate through hydrogen bond interactions, and tannic acid and iron form stable complexes under neutral or weakly alkaline conditions, promoting the electron transfer between microbials and exogenous electron acceptors, and long-term stirring may promote the full reaction of tannic acid and iron.

(4) transferring the mixed solution in step (3) together with pretreated carbon felt into a reactor for hydrothermal synthesis, natural cooling, washing with deionized water, and vacuum drying to obtain the tannic acid-modified iron-biochar composite conductive carrier.

It should be indicated that in the present disclosure, the Fe-TA-C composite material is grown in situ via hydrothermal synthesis to form a conductive composite carrier, which exhibits advantages of large surface area, strong electrical conductivity, and excellent chemical stability. On the one hand, it may be used as an immobilized carrier without the issue of loss, avoiding the problem of powder material recovery and the impact on subsequent processes, and has certain economic feasibility. On the other hand, it may induce microbial attachment to form a functional biofilm, enhance direct interspecies electron transfer (DIET) during anaerobic processes, and ultimately improve methanogenesis performance and achieve efficient energy recovery.

In one or more embodiments, in step (1), the biochar is wooden biochar, the calcination temperature is 450-550° C., the calcination time is 1-3 h, and the heating rate is 5-10° C./min.

In one or more embodiments, in step (1), the washing alternately with deionized water and ethanol, drying and sieving for later use includes: washing alternately with deionized water and ethanol for 3-4 times, drying at 60-65° C. for a drying time of 8-12 h, and sieving to obtain 100-150 mesh powder for later use.

In one or more embodiments, in step (2), 0.50-1.0 g of biochar and 0.02-0.05 g of the soluble iron salt are added per 40-50 mL of deionized water. In one or more embodiments, the soluble iron salt is FeCl₃·6H₂O or Fe(NO₃)₃·9H₂O.

In one or more embodiments, in step (3), 0.04-0.32 g of tannic acid is added, and the molar ratio of tannic acid to iron is 1:1-1:3. 0.1-0.2 M NaOH or KOH solution is added dropwise until the pH of the mixed solution is 7-9.

In one or more embodiments, when tannic acid is not added in step (3), an iron-biochar composite conductive carrier is obtained by the preparation method.

In one or more embodiments, in step (4), the carbon felt pretreatment method includes: soaking a piece of carbon felt of (2-5)×(2-6)×(0.1-0.2) cm³ in a hydrogen peroxide solution with 30% mass concentration for 1-2 h under a 80-90° C. water bath condition; and rinsing with deionized water to a neutral pH value, and drying in an oven at 60-65° C. for 3-6 h to obtain the pretreated carbon felt. The pretreatment may enable the carbon felt to carry hydroxyl groups, increase the proportion of oxygen-containing functional groups to be better combined with TA, enhance the redox ability of the composite conductive carrier, and promote electron transfer.

In one or more embodiments, in step (4), the temperature of the hydrothermal synthesis is 120-140° C., and the time of the hydrothermal synthesis is 12-16 h.

In one or more embodiments, the natural cooling, washing with deionized water and vacuum drying includes naturally cooling to 60° C. or below, then washing with deionized water for 3-4 times, and vacuum drying at a temperature of 60-65° C. for a drying time of 8-12 h.

Embodiments of the present disclosure further provide a tannic acid-modified iron-biochar composite conductive carrier prepared by the preparation method described above, where the tannic acid-modified iron-biochar composite conductive carrier is a Fe-TA-C composite conductive carrier that promotes electron transfer.

Embodiments of the present disclosure further provide an application of a tannic acid-modified iron-biochar composite conductive carrier prepared by the preparation method described above in environmental remediation and pollution control technologies.

Embodiments of the present disclosure further provide an application of a tannic acid-modified iron-biochar composite conductive carrier prepared by the preparation method described above in the anaerobic treatment of wastewater, which may be applied to various scenarios such as municipal wastewater, industrial wastewater, and aquaculture wastewater.

Embodiments of the present disclosure further provide an anaerobic treatment method for wastewater, including: using the above-mentioned method to prepare an iron-biochar composite conductive carrier or a tannic acid-modified iron-biochar composite conductive carrier, placing the iron-biochar composite conductive carrier or the tannic acid-modified iron-biochar composite conductive carrier and anaerobic suspended sludge in an anaerobic reactor, introducing the wastewater to be treated to degrade organic pollutants by biodegradation.

In one or more embodiments, the introducing the wastewater to be treated to degrade the organic pollutants by biodegradation includes: introducing the wastewater to be treated for mixed culture (without removing anaerobic suspended sludge) to generate a biofilm to degrade the organic pollutants by biodegradation.

In one or more embodiments, the introducing the wastewater to be treated to degrade the organic pollutants by biodegradation includes: continuously introducing the wastewater to be treated for acclimatization and pre-operation for 2-10 days to generate a biofilm, removing the anaerobic suspended sludge, and continuing to continuously introduce the wastewater to be treated to degrade the organic pollutants by biodegradation. During the period of acclimatization and pre-operation, the biofilm is induced to form on the surface of the carrier, and then the anaerobic suspended sludge is removed. During the entire process of introducing the wastewater to be treated (i.e., during the acclimatization and pre-operation period and the subsequent wastewater introduction period), the wastewater to be treated is continuously introduced, and the treated water is also continuously discharged to achieve continuous flow treatment. In this way, an efficient, stable, and industrially applicable large-scale water treatment operation may be achieved.

In one or more embodiments, during the introduction of the wastewater to be treated, the pH is maintained at 7.0-8.5 and the hydraulic retention time is 6 h-12 h.

In one or more embodiments, the concentration of the anaerobic suspended sludge is 5-6 gVSS/L.

In one or more embodiments, the addition amount of the tannic acid-modified iron-biochar composite conductive carrier is 0.05-0.1 g/L, calculated as Fe-TA-C, which is equivalent to a Fe-TA-C loading amount on the carbon felt of 0.5-2 mg/cm².

In one or more embodiments, the iron-biochar composite conductive carrier or tannic acid-modified iron-biochar composite conductive carrier may be used by directly adding and suspending, or vertically arranging individual sheets, or roll-like arrangement in which it is rolled and has ends connected to form a hollow cylindrical structure, or chain-like stacking arrangement of multiple groups, or other application methods.

In one or more embodiments, the anaerobic reactor includes a batch flow reactor, a semi-continuous flow reactor, and a continuous flow reactor.

In one or more embodiments, the anaerobic reactor includes an anaerobic bioreactor bottle or an anaerobic fixed biofilm reactor.

In one or more embodiments, the operating temperature of the anaerobic reactor is kept at a room temperature. In one or more embodiments, the room temperature may be 15-20° C. In one or more embodiments, the room temperature may be 35-37° C. Therefore, the anaerobic reactor of the present disclosure may operate at a normal room temperature in any season without requiring a specific temperature, enabling simple operating requirements.

In one or more embodiments, before the anaerobic reactor is operated, nitrogen gas is used to purge for 5-15 min to maintain anaerobic conditions. The anaerobic reactor is placed in a constant-temperature magnetic stirrer with a stirring rate of 100-150 r/min.

In one or more embodiments, the wastewater to be treated is municipal wastewater, industrial wastewater or aquaculture wastewater.

Compared with the prior art, the present disclosure has the following advantages:
(1) the present disclosure prepares an iron-biochar composite conductive carrier or a tannic acid-modified iron-biochar composite conductive carrier by a simple low-temperature hydrothermal synthesis method, which features low raw material cost, simple method, good electrical conductivity, recyclability, and high stability; and
(2) the iron-biochar composite conductive carrier or tannic acid-modified iron-biochar composite conductive carrier prepared by the present disclosure may store and release electrons, and enhance the direct interspecies electron transfer between acidogenic bacteria and methanogenic bacteria during the anaerobic treatment process; and the immobilization of tannic acid-modified iron and biochar on the carbon felt is conducive to the formation of biofilm, which not only solves the problem of conductive material recovery but also significantly increases methane production.

To facilitate better understanding of the present disclosure, the following examples are provided for further specific illustration of the present disclosure, but shall not be construed as limiting the present disclosure. For a person skilled in the art, some non-essential improvements and adjustments made based on the above-disclosed content shall also be deemed to fall within the protection scope of the present disclosure.

### Example 1

In this example, an iron-biochar composite conductive carrier and a tannic acid-modified iron-biochar composite conductive carrier were prepared.

A preparation method of the tannic acid-modified iron-biochar composite conductive carrier included the following steps:
(1) calcining a wooden raw material at a high temperature to obtain biochar, natural cooling, washing alternately with deionized water and ethanol, drying, and sieving for later use;
(2) dissolving biochar and FeCl₃·6H₂O in deionized water and performing magnetic stirring for 30 min;
(3) adding tannic acid (TA) after full dissolution, continuing stirring for 6 h, adjusting the pH value of the obtained mixed solution to 7 by using NaOH; and
(4) transferring the mixed solution after pH adjustment in step (3) together with pretreated carbon felt into a 100 mL reactor for hydrothermal synthesis, natural cooling, washing with deionized water, vacuum drying to obtain a tannic acid-modified iron-biochar composite conductive carrier, named Fe-TA-C@CF.

In step (1), the biochar was a wooden biochar, the calcination temperature was 500° C., the calcination time was 2 h, and the washing alternately with deionized water and ethanol was performed for 3 times, followed by drying at 60° C. for a drying time of 12 h, and sieving to obtain 150 mesh powder for later use.

In step (2), 1.0 g of biochar and 0.02 g of FeCl₃·6H₂O were added in sequence per 40 mL of deionized water.

In step (3), 0.06 g of tannic acid was added, with a molar ratio of tannic acid to iron of 1:2, and 0.1 M NaOH solution was added dropwise until the pH of the mixed solution reached 7.

In step (4), the carbon felt pretreatment method included: soaking a piece of carbon felt of 2×2×0.2 cm³ in a hydrogen peroxide solution with 30% mass concentration for 1.5 h under a 90° C. water bath condition, rinsing with deionized water to a neutral pH value, and drying in an oven at 60° C. for 5 h to obtain the pretreated carbon felt.

In step (4), the hydrothermal synthesis temperature was 120° C., the hydrothermal synthesis time was 14 h, deionized water was used for washing for 3 times after natural cooling to 60° C. or below, the vacuum drying temperature was 60° C., and the drying time was 12 h.

The preparation method of the iron-biochar composite conductive carrier was the same as that of the aforementioned tannic acid-modified iron-biochar composite conductive carrier, with the only difference being that TA was not added in step (3). The prepared iron-biochar composite conductive carrier was named Fe—C@CF.

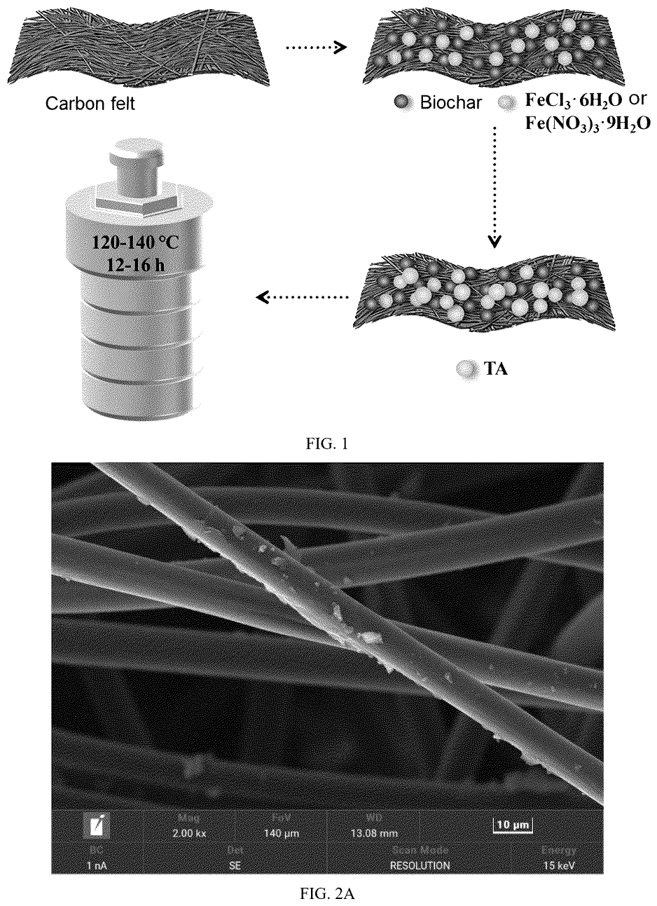

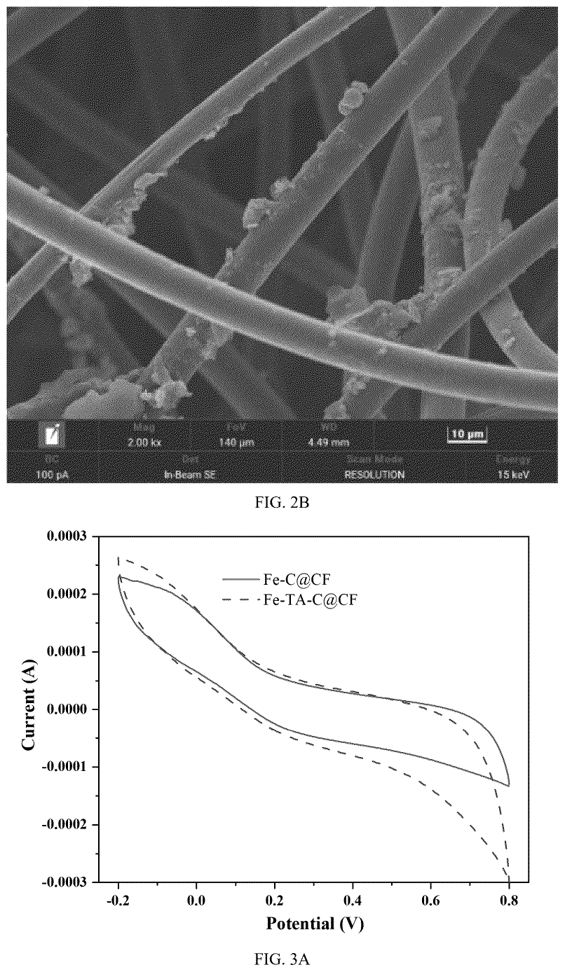

The preparation flow chart of the tannic acid-modified iron-biochar composite conductive carrier (i.e., Fe-TA-C@CF) is shown in FIG. 1, the scanning electron microscope image of the iron-biochar composite conductive carrier (i.e., Fe—C@CF) is shown in FIG. 2A, and the scanning electron microscope image of the tannic acid-modified iron-biochar composite conductive carrier (i.e., Fe-TA-C@CF) is shown in FIG. 2B.

### Example 2

In this example, an iron-biochar composite conductive carrier and a tannic acid-modified iron-biochar composite conductive carrier were prepared.

A preparation method of the tannic acid-modified iron-biochar composite conductive carrier included the following steps:
(1) calcining a wooden raw material at a high temperature to obtain biochar, natural cooling, washing alternately with deionized water and ethanol, drying, and sieving for later use;
(2) dissolving biochar and FeCl₃·6H₂O in deionized water and performing magnetic stirring for 40 min;
(3) adding tannic acid (TA) after full dissolution, continuing stirring for 8 h, and adjusting the pH value of the obtained mixed solution to 9 by using NaOH; and
(4) transferring the mixed solution after pH adjustment in step (3) together with pretreated carbon felt into a 100 mL reactor for hydrothermal synthesis, natural cooling, washing with deionized water, and vacuum drying to obtain a tannic acid-modified iron-biochar composite conductive carrier, named Fe-TA-C@CF.

In step (1), the biochar was a wooden biochar, the calcination temperature was 550° C., the calcination time was 1.5 h, and the washing alternately with deionized water and ethanol was performed for 3 times, followed by drying at 60° C. for a drying time of 12 h, and sieving to obtain 100 mesh powder for later use.

In step (2), 1.0 g of biochar and 0.05 g of FeCl₃·6H₂O were added in sequence per 50 mL of deionized water.

In step (3), 0.31 g of tannic acid was added, with a molar ratio of tannic acid to iron of 1:1, and 0.2 M NaOH solution was added dropwise until the pH of the mixed solution reached 9.

In step (4), the carbon felt pretreatment method included: soaking a piece of carbon felt of 4×4×0.1 cm³ in a hydrogen peroxide solution with 30% mass concentration for 2 h under an 85° C. water bath condition, rinsing with deionized water to a neutral pH value, and drying in an oven at 60° C. for 6 h to obtain the pretreated carbon felt.

In step (4), the hydrothermal synthesis temperature was 130° C., the hydrothermal synthesis time was 16 h, deionized water was used for washing for 3 times after natural cooling to 60° C. or below, the vacuum drying temperature was 65° C., and the drying time was 8 h.

The preparation method of the iron-biochar composite conductive carrier was the same as that of the aforementioned tannic acid-modified iron-biochar composite conductive carrier, with the only difference being that TA was not added in step (3). The prepared iron-biochar composite conductive carrier was named Fe—C@CF.

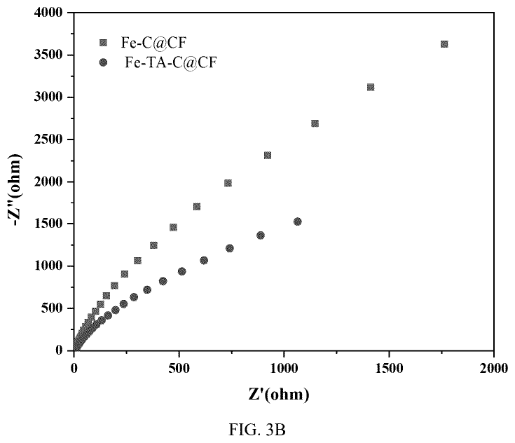

The composite conductive carriers Fe—C@CF and Fe-TA-C@CF prepared by the above methods were subjected to electrochemical cyclic voltammogram CV (data as shown in FIG. 3A) and electrochemical impedance spectroscopy EIS plot (data as shown in FIG. 3B) tests. At a scan rate of 50 mV/s, integration of the CV curve (a) revealed that the electrochemically active area (ECSA) of Fe-TA-C@CF was higher than that of Fe—C@CF. Equivalent circuit calculation of the electron transfer resistance (Rct) from the EIS spectrum (FIG. 3B) revealed that Fe-TA-C@CF<Fe—C@CF.

This result indicated that the interfacial electron transfer resistance was significantly reduced due to the appropriate Fe-TA molar ratio doping; compared with Fe—C@CF, Fe-TA-C@CF had more active sites, stronger electrical conductivity, and smaller electron transfer resistance, which may create a more suitable growth environment for anaerobic microbials and ultimately enhance direct interspecies electron transfer (DIET).

### Example 3

In this example, an iron-biochar composite conductive carrier and a tannic acid-modified iron-biochar composite conductive carrier were prepared.

A preparation method of a tannic acid-modified iron-biochar composite conductive carrier included the following steps:
(1) calcining a wooden raw material at a high temperature to obtain biochar, natural cooling, washing alternately with deionized water and ethanol, drying, and sieving for later use;
(2) dissolving biochar and FeCl₃·6H₂O in deionized water and performing magnetic stirring for 30 min;
(3) adding tannic acid (TA) after full dissolution, continuing stirring for 6 h, adjusting the pH value of the obtained mixed solution to 8 by using NaOH; and
(4) transferring the mixed solution after pH adjustment in step (3) together with pretreated carbon felt into a 100 mL reactor for hydrothermal synthesis, natural cooling, washing with deionized water, and vacuum drying to obtain a tannic acid-modified iron-biochar composite conductive carrier, named Fe-TA-C@CF.

In step (1), the biochar was a wooden biochar, the calcination temperature was 450° C., the calcination time was 3 h, and the washing alternately with deionized water and ethanol was performed for 4 times, followed by drying at 65° C. for a drying time of 8 h, and sieving to obtain 150 mesh powder for later use.

In step (2), 1.0 g of biochar and 0.02 g of FeCl₃·6H₂O were added in sequence per 40 mL of deionized water.

In step (3), 0.04 g of tannic acid was added, with a molar ratio of tannic acid to iron of 1:3, and 0.1 M NaOH solution was added dropwise until the pH of the mixed solution reached 8.

In step (4), the carbon felt pretreatment method included: soaking a piece of carbon felt of 5×5×0.1 cm³ in a hydrogen peroxide solution with 30% mass concentration for 1 h under a 90° C. water bath condition, rinsing with deionized water to a neutral pH value, and drying in an oven at 65° C. for 3 h to obtain the pretreated carbon felt.

In step (4), the hydrothermal synthesis temperature was 140° C., the hydrothermal synthesis time was 12 h, deionized water was used for washing for 3 times after natural cooling to 60° C. or below, the vacuum drying temperature was 65° C., and the drying time was 8 h.

The preparation method of the iron-biochar composite conductive carrier was the same as that of the aforementioned tannic acid-modified iron-biochar composite conductive carrier, with the only difference being that TA was not added in step (3). The prepared iron-biochar composite conductive carrier was named Fe—C@CF.

### Example 4

In this example, a tannic acid-modified iron-biochar composite conductive carrier was prepared, and the preparation method thereof included the following steps:
(1) calcining a wooden raw material at a high temperature to obtain biochar, natural cooling, washing alternately with deionized water and ethanol, drying, and sieving for later use;
(2) dissolving biochar and FeCl₃·6H₂O in deionized water and performing magnetic stirring for 30 min;
(3) adding tannic acid (TA) after full dissolution, continuing stirring for 6 h, adjusting the pH value of the obtained mixed solution to 7 by using NaOH; and
(4) transferring the mixed solution after pH adjustment in step (3) together with pretreated carbon felt into a 100 mL reactor for hydrothermal synthesis, natural cooling, washing with deionized water, and vacuum drying to obtain a tannic acid-modified iron-biochar composite conductive carrier, named Fe-TA-C@CF.

In step (1), the biochar was a wooden biochar, the calcination temperature was 500° C., the calcination time was 2 h, and the washing alternately with deionized water and ethanol was performed for 3 times, followed by drying at 60° C. for a drying time of 12 h, and sieving to obtain 150 mesh powder for later use.

In step (2), 1.0 g of biochar and 0.02 g of FeCl₃·6H₂O were added in sequence per 40 mL of deionized water.

In step (3), 0.06 g of tannic acid was added, with a molar ratio of tannic acid to iron of 1:2, and 0.1 M NaOH solution was added dropwise until the pH of the mixed solution reached 7.

In step (4), the carbon felt pretreatment method included: soaking a piece of carbon felt of 5×6×0.2 cm³ in a hydrogen peroxide solution with 30% mass concentration for 1.5 h under a 90° C. water bath condition, rinsing with deionized water to a neutral pH value, and drying in an oven at 60° C. for 5 h to obtain the pretreated carbon felt.

In step (4), the hydrothermal synthesis temperature was 120° C., the hydrothermal synthesis time was 12 h, deionized water was used for washing for 3 times after natural cooling to 60° C. or below, the vacuum drying temperature was 60° C., and the drying time was 12 h.

To further demonstrate the beneficial effects of the present disclosure and to facilitate better understanding of the present disclosure, the following Application Examples are provided to further illustrate the technical features of the present disclosure, but are not to be construed as limitations of the present disclosure. Other improvements made by those skilled in the art based on the above disclosure without inventive work are also deemed to fall within the scope of protection of the present disclosure.

### Application Example 1

In the present application example, three sets of experiments were conducted. Specifically, the group where Fe—C@CF and anaerobic suspended sludge 1 were added to the anaerobic bioreactor bottle 10 was referred to as the Fe—C@CF group; the group where Fe-TA-C@CF and anaerobic suspended sludge 1 were added to the anaerobic bioreactor bottle 10 was referred to as the Fe-TA-C@CF group; and the group where only anaerobic suspended sludge 1 was added to the anaerobic bioreactor bottle 10 without any composite conductive carrier 4 added was referred to as the control group. The specific experiments were as follows.

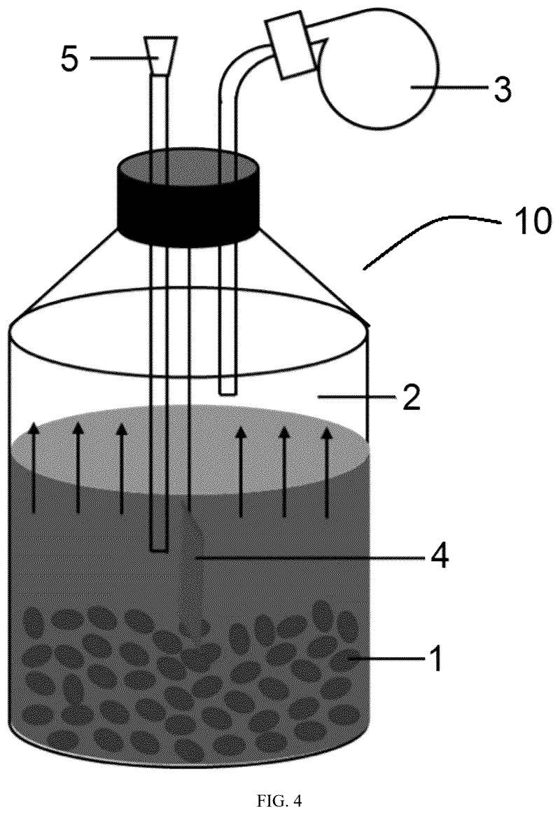

Anaerobic suspended sludge 1 was placed in a 250 mL anaerobic bioreactor bottle 10 to obtain the control group. Anaerobic suspended sludge 1 and composite conductive carriers (Fe—C@CF and Fe-TA-C@CF) prepared by the method of Example 3 were respectively placed in 250 mL anaerobic bioreactor bottles 10 to obtain the Fe—C@CF group and the Fe-TA-C@CF group. In the above, the added anaerobic suspended sludge 1 was taken from an anaerobic UASB reactor that had been stably operated in the laboratory for one year, and the concentration of the anaerobic suspended sludge was 5 gVSS/L. As shown in FIG. 4, the added composite conductive carrier was in a sheet form, vertically suspended in the anaerobic bioreactor bottle 10 and submerged below the wastewater liquid surface. The effective contact area of the added composite conductive carrier was 2×2×0.1 cm³, and the addition amount of the composite conductive carrier was 0.05 g/L, calculated as Fe-TA-C, that is, the loading amount of Fe-TA-C on the carbon felt is 1 mg/cm².

Then, the following steps were performed for each group.

Before operation, the anaerobic bioreactor bottle was purged with nitrogen gas for 15 min to maintain anaerobic conditions. After being connected properly, the anaerobic bioreactor bottle was placed in a constant-temperature magnetic stirrer for culturing at 37° C., with the rotation speed (i.e., the stirring rate) maintained at 150 r/min. 200 mL of wastewater was introduced into the anaerobic bioreactor bottle 10 for mixed culture for 10 days to enrich an anaerobic biofilm, thereby biodegrading organic pollutants. In the above, throughout the mixed culture period, the pH was maintained at 7.5, and the hydraulic retention time was set to 12 h.

The wastewater fed had a COD concentration of 500 mg COD/L. Ammonium chloride and potassium dihydrogen phosphate were added to provide nitrogen and phosphorus sources required for microbial growth and metabolism, respectively, where the mass ratio of carbon, nitrogen and phosphorus was 100:5:1. Sodium bicarbonate at a concentration of 500 mg/L was used as a pH buffer. The bottom liquid zone of the anaerobic bioreactor bottle served as the main reaction zone, while the upper part was the headspace gas zone (i.e., biogas zone) 2. A gas collection bag 3 communicated with the headspace gas zone 2 to collect biogas produced within the anaerobic bioreactor bottle, where the carrier was fixed and vertically immersed in the sludge suspension solution. A hose used at a sampling port had a bottom submerged under the liquid surface and the upper part of the hose was sealed with a water-stop clamp. a sampling needle 5 may be inserted into the hose for sampling. A total of 20 cycles of mixed culture was conducted. During each of the 1st, 3rd, 5th, 7th, 9th, 11th, 13th, 15th, 17th, and 19th cycles, water samples were collected at the 4th h, 8th h, and 12th h respectively to determine the total organic carbon (TOC) in the solution. After the completion of the 20th cycle, the cumulative gas production and biogas components in the gas collection bag 3 were measured to evaluate the effect of the Fe—C@CF composite conductive carrier and Fe-TA-C@CF composite conductive carrier in mediating the microbial-carrier interface for the synergistic regulation of anaerobic biological treatment of wastewater.

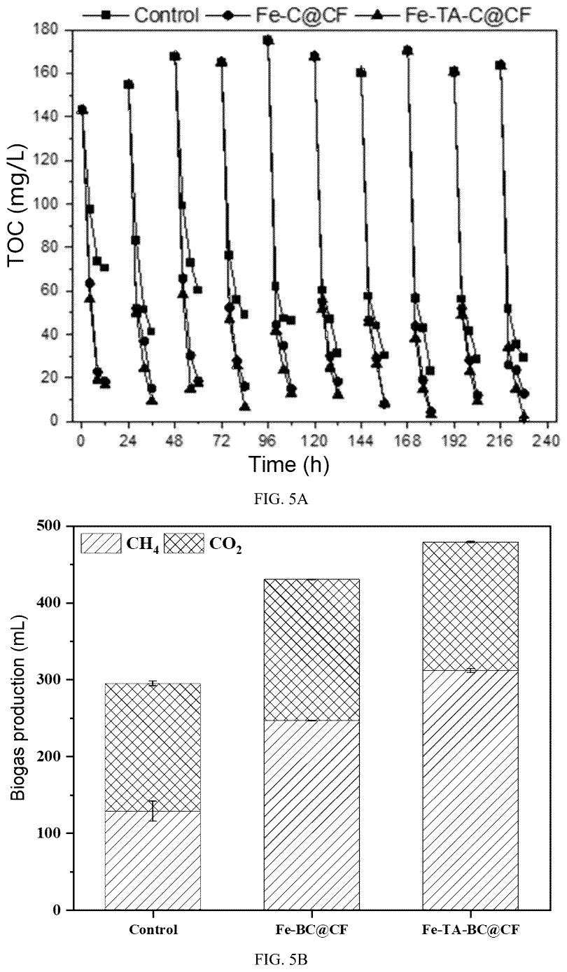

As shown in FIG. 5A, a total organic carbon (TOC) analyzer was used to test the variation of TOC over time to investigate the removal rate of organic matters. It can be seen from the figure that TOC degradation rates in the three groups initially increase rapidly and then decrease, but obviously, the TOC removal rates in the Fe—C@CF group and Fe-TA-C@CF group were higher than that in the control group. Compared with the control group (74.5±10.7%), TOC removal rates in the Fe—C@CF group and Fe-TA-C@CF group were 91.6±2.9% and 94.7±2.0%, respectively.

As shown in FIG. 5B, the cumulative gas production during the entire reaction process for each of the control, Fe—C@CF, and Fe-TA-C@CF groups, collected by using the gas collection bag 3, was detected by gas chromatography (TCD). Compared with the control group, the cumulative methane production in the Fe—C@CF group and Fe-TA-C@CF group increased by 45.7% and 62.4%, respectively. This indicated that the iron-biochar composite conductive carrier and the tannic acid-modified iron-biochar composite conductive carrier can store and release electrons, induce functional biofilm formation, enhance electron transfer at the microbial-carrier interface, and significantly increase methane production. Additionally, the iron-biochar composite conductive carrier and the tannic acid-modified iron-biochar composite conductive carrier solve the problem of conductive material recycling, use low-cost highly stable raw materials, and have technical, environmental, and economic advantages, thus making them promising sustainable alternatives to traditional carriers in anaerobic wastewater biological treatment systems.

### Application Example 2

The application experiment of a tannic acid-modified iron-biochar composite conductive carrier was as follows.

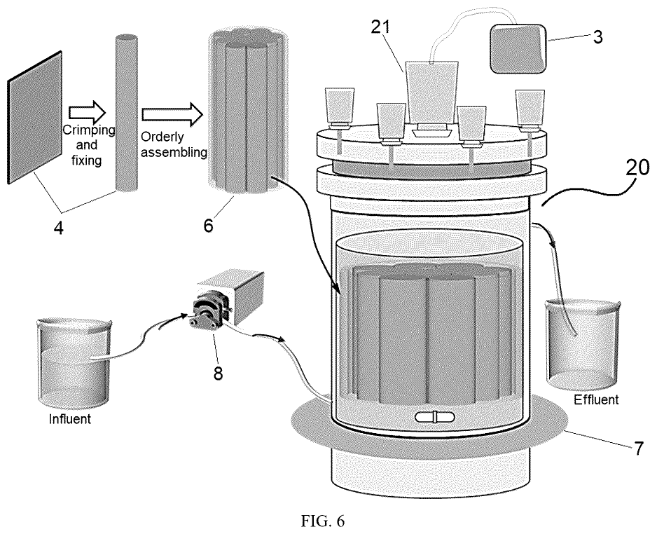

Anaerobic suspended sludge 1 and the composite conductive carrier Fe-TA-C@CF prepared in the method of Example 4 were placed in a cylindrical anaerobic reactor with a diameter of 10 cm, a height of 15 cm, and an effective volume of 1 L, namely, anaerobic fixed biofilm reactor 20 as shown in FIG. 6. All joints in the anaerobic fixed biofilm reactor 20 were sealed with silicone to prevent oxygen infiltration. A gas collection bag 3 was connected to the top of a transparent circular gas collecting tube 21. In the above, the composite conductive carrier Fe-TA-C@CF with 5 cm in length and 6 cm in height forms a hollow cylindrical structure by butt-jointing, crimping and fixing its ends. Eleven hollow cylindrical structures were evenly distributed on a disc 7 (i.e., the Fe-TA-C@CF carrier model 6 was placed on the disc 7), where the effective area of the Fe-TA-C@CF was 660 cm². The aforementioned anaerobic suspended sludge was taken from a UASB reactor that had been stably operated in the laboratory for one year, and the concentration of the anaerobic suspended sludge was 5 g VSS/L.

Before the anaerobic fixed biofilm reactor 20 was put into operation, nitrogen gas was purged into for 15 min to ensure an anaerobic environment. After being connected properly, the anaerobic fixed biofilm reactor 20 was placed in a constant-temperature magnetic stirrer for culturing at 37° C., with the rotation speed maintained at 150 r/min. Influent (i.e., wastewater) was added to the anaerobic fixed biofilm reactor via a peristaltic pump 8. The wastewater fed had a COD concentration of 500 mg COD/L. Ammonium chloride and potassium dihydrogen phosphate were added to provide nitrogen and phosphorus sources required for microbial growth and metabolism respectively, where the mass ratio of carbon, nitrogen and phosphorus was 100:5:1. Sodium bicarbonate at a concentration of 500 mg/L was used as a pH buffer. After the addition of wastewater, acclimatization and pre-operation was performed for 7 days. After the biofilm on the carrier was enriched and stabilized, all the inoculated anaerobic suspended sludge was discharged. The biomass enriched in situ on the carrier in the anaerobic fixed biofilm reactor was 1.5 g VSS/L. Stable operation was then carried out, where during the continuous flow treatment period (i.e., the entire period of continuous wastewater introduction), the hydraulic retention time (HRT) was 6 h, the gas production was recorded every other day, and the effluent was collected every 2 days to measure the COD concentration. A total of 10 days of data were recorded to preliminarily evaluate the stability of the biofilm enriched on the Fe-TA-C@CF composite conductive carrier and the methane production capacity. In the above, the daily gas production of the Fe-TA-C@CF collected in the gas collection bag 3 was detected by gas chromatography (TCD), and the influent COD and effluent COD of the anaerobic fixed biofilm reactor were measured by using a COD digestion instrument.

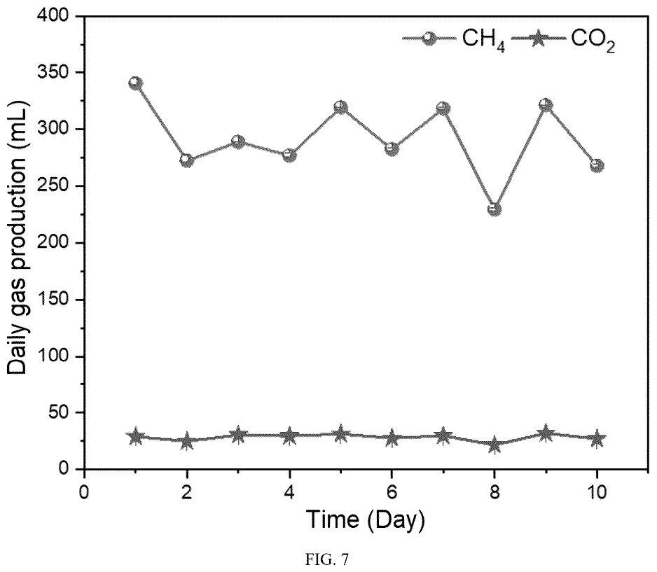

The daily gas production results of the anaerobic fixed biofilm reactor after 10 days of operation are as shown in FIG. 7, and the influent COD and effluent COD results are as shown in Table 1 below.

TABLE 1
Results of Influent COD and Effluent COD of Anaerobic
fixed Biofilm Reactor after 10 Days of Operation

| Running time (days) | Influent COD (mg/L) | Effluent COD (mg/L) |
|---|---|---|
| 2 | 504.4 | 10.27 |
| 4 | 500 | 12.32 |
| 6 | 497 | 16.43 |
| 8 | 495.2 | 6.16 |
| 10 | 501.6 | 17.78 |

From the results in FIG. 7, it can be observed that for the anaerobic fixed biofilm reactor using Fe-TA-C@CF, the daily methane production is 300-350 mL, and the daily carbon dioxide production is 12-15 mL. This indicates that after scaling up and upgrading, the tannic acid-modified iron-biochar composite conductive carrier has higher biofilm stability and capacity of enriching methanogenic bacteria, and can significantly increase biofilm-dependent methane production, thus achieving the in-situ upgrading of biogas, that is, realizing continuous and efficient anaerobic wastewater treatment.

In addition, based on the data in Table 1, it can be calculated that the COD removal rate is as high as 96%-99%. Through conversion, it is known that for every 1 g of COD removed, the methane production of the biofilm reaches 0.4-0.6 L, which is 1.6-2.4 times higher than the theoretical methane production value of conventional anaerobic suspended sludge, which indicates that Fe-TA-C@CF synergistically enhances the electron transfer efficiency and metabolic activity of the biofilm. Furthermore, the conductive carrier-biofilm model can be extended to various types of reactors, demonstrating significant potential for improving energy recovery and reducing carbon emissions.

The above description of the disclosed embodiments enables one skilled in the art to implement or use the present disclosure. Various modifications to these embodiments will be apparent to one skilled in the art, and the general principles defined herein may be implemented in other embodiments without departing from the spirit or scope of the present disclosure. Therefore, the present disclosure is not limited to the embodiments shown herein but is intended to conform to the widest scope consistent with the principles and novel features disclosed herein.

1. A preparation method of a tannic acid-modified iron-biochar composite conductive carrier, comprising the following steps:
(1) calcining a wooden raw material at a high temperature to obtain biochar, natural cooling, washing alternately with deionized water and ethanol, drying, and sieving for later use;
(2) dissolving the biochar obtained in step (1) and a soluble iron salt in deionized water and performing magnetic stirring;
(3) adding tannic acid after full dissolution to obtain a mixed solution, and adjusting a pH value of the mixed solution with an alkali solution; and
(4) transferring the mixed solution after pH adjustment in step (3) together with a pretreated carbon felt into a reactor for hydrothermal synthesis, natural cooling, washing with deionized water, and vacuum drying to obtain the tannic acid-modified iron-biochar composite conductive carrier.

2. The preparation method of a tannic acid-modified iron-biochar composite conductive carrier according to claim 1, wherein the adding tannic acid after full dissolution to obtain the mixed solution and adjusting the pH value of the mixed solution with the alkali solution in step (3) comprises:
adding the tannic acid after full dissolution, continuing stirring for 6-8 h, and adjusting the pH value of the mixed solution to 7-9 by using NaOH or KOH.

3. The preparation method of a tannic acid-modified iron-biochar composite conductive carrier according to claim 1, wherein in step (2), 0.50-1.0 g of the biochar and 0.02-0.05 g of the soluble iron salt are added per 40-50 mL of deionized water.

4. The preparation method of a tannic acid-modified iron-biochar composite conductive carrier according to claim 1, wherein the soluble iron salt is FeCl₃·6H₂O or Fe(NO₃)₃·9H₂O.

5. The preparation method of a tannic acid-modified iron-biochar composite conductive carrier according to claim 1, wherein in step (3), 0.04-0.32 g of the tannic acid is added, a molar ratio of the tannic acid to iron is 1:1-1:3, and 0.1-0.2 M NaOH or KOH solution is added dropwise until the pH value of the mixed solution is 7-9.

6. The preparation method of a tannic acid-modified iron-biochar composite conductive carrier according to claim 1, wherein when the tannic acid is not added in step (3), an iron-biochar composite conductive carrier is obtained by the preparation method.

7. The preparation method of a tannic acid-modified iron-biochar composite conductive carrier according to claim 1, wherein in step (4), a carbon felt pretreatment method comprises: soaking a piece of carbon felt of (2-5)×(2-6)×(0.1-0.2) cm³ in a hydrogen peroxide solution with 30% mass concentration for 1-2 h under a 80-90° C. water bath condition; and rinsing with deionized water to a neutral pH value, and drying in an oven at 60-65° C. for 3-6 h to obtain the pretreated carbon felt.

8. The preparation method of a tannic acid-modified iron-biochar composite conductive carrier according to claim 1, wherein in step (4), a temperature of the hydrothermal synthesis is 120-140° C., and a time of the hydrothermal synthesis is 12-16 h.

9. The preparation method of a tannic acid-modified iron-biochar composite conductive carrier according to claim 1, wherein the tannic acid-modified iron-biochar conductive carrier is a Fe-TA-C composite conductive carrier that promotes electron transfer.

10. An anaerobic treatment method for wastewater, comprising:
preparing a tannic acid-modified iron-biochar composite conductive carrier by the preparation method according to claim 1;
placing the tannic acid-modified iron-biochar composite conductive carrier and anaerobic suspended sludge in an anaerobic reactor; and
introducing wastewater to be treated to degrade organic pollutants through biodegradation.

11. The anaerobic treatment method for wastewater according to claim 10, wherein the introducing the wastewater to be treated to degrade the organic pollutants by biodegradation comprises: continuously introducing the wastewater to be treated for acclimatization and pre-operation for 2-10 days to generate a biofilm, removing the anaerobic suspended sludge, and continuing to continuously introduce the wastewater to be treated to degrade the organic pollutants by biodegradation.

12. The anaerobic treatment method for wastewater according to claim 11, wherein during the introduction of the wastewater to be treated, pH is maintained at 7.0-8.5 and a hydraulic retention time is 6 h-12 h.

13. The anaerobic treatment method for wastewater according to claim 11, wherein a concentration of the anaerobic suspended sludge is 5-6 gVSS/L.

14. The anaerobic treatment method for wastewater according to claim 11, wherein an addition amount of the tannic acid-modified iron-biochar composite conductive carrier is 0.05-0.1 g/L, calculated as tannic acid-modified iron-biochar (Fe-TA-C).

15. The anaerobic treatment method for wastewater according to claim 11, wherein the anaerobic reactor comprises a batch flow reactor, a semi-continuous flow reactor, and a continuous flow reactor.

16. The anaerobic treatment method for wastewater according to claim 11, wherein the anaerobic reactor is an anaerobic bioreactor bottle or an anaerobic fixed biofilm reactor.

17. The anaerobic treatment method for wastewater according to claim 11, wherein an operating temperature of the anaerobic reactor is a room temperature.

18. The anaerobic treatment method for wastewater according to claim 11, wherein the wastewater to be treated is municipal wastewater, industrial wastewater or aquaculture wastewater.
